(19) United States
(12) Patent Application Publication
(10) Pub. No.: US 2002/0014145 A1
(43) Pub. Date: Feb. 7, 2002

(54) DATA PROCESSOR

(76) Inventor: AKIRA SUGIYAMA, KAWASAKI-SHI (JP)

Correspondence Address: STAAS & HALSEY LLP, 700 11TH STREET, NW, SUITE 500, WASHINGTON, DC, 20001, US

(21) Appl. No.: 09/377,827

(22) Filed: Aug. 20, 1999

(30) Foreign Application Priority Data
Aug. 21, 1998 (JP) 235660/1998

(51) Int. Cl. G09B 15/02

(52) U.S. Cl. 84/483.2

(57) ABSTRACT

A data processor using computer and a staff notation have a listing of note code table corresponding with data input to said computer and scales of music staff notation, a note decoder decoding from input data to corresponded scale code data using said listing of note code table, a note code storage device memorizing output data from said note decoder with in order, and an output means for output the music staff notation data from the note code storage device. Plural list of note code table are able to set in note decoder selectably.

### BACKGROUND OF THE INVENTION

1. Field of the Invention

The present invention relates to a data processor, and more particularly, relates to a data processor using computer and a musical staff notation.

2. Description of the Prior Art

Human beings express their thoughts or ideas in sounds as words and then record them as writing. Human beings can also represent their ideas directly using the written word. Since the days of antiquity, human beings have expressed themselves using media such as stone, narrow strips of wood or bamboo, and paper. When it is desired to copy writing from a hardware medium, e.g., words written on a stone, a photograph of the words written on the stone may be taken and it may be printed. However, if it is necessary to edit such words by making corrections, additions or deletions converting to the content of the writing, the words must be rewritten.

Recently, it has become common, by converting written characters into symbols, to express the characters constituting words as an arrangement of such symbols and to retain the same in storage, and, later, to read out the data from the storage and edit the data of the sentence by means of the processing fiction of a computer.

A symbolized character is expressed by a combination of 8 bits or 16 bits which are either “1” or “0”, and therefore the number of bits representing all the data will amount to the maximum number of characters multiplied by 16. As a result, when storing these data in a medium, a large storage area will be required.

The present invention was made to overcome such a difficulty and it is an object of the invention to provide a method of expressing data in which the data storage area in a medium is minimized and data processing such as writing is simplified.

### SUMMARY OF THE INVENTION

In order to achieve the above mentioned object of the invention, there is provided a device of processing data between expressed character and symbol data and signal data characterized by that a code table, in which each scale in the music staff is correlated with each of the exhibited characters and symbols, has previously been made, the exhibited character and symbol data are converted into data in the form of scales on the music staff in accordance with the code table whereby the characters and symbols are converted into an arrangement of data in the form of scales, and, further, the arrangement of data of scales is converted into an arrangement of data of characters and symbols on the basis of the scales in accordance with the code table.

### BRIEF DESCRIPTION OF THE DRAWINGS

FIG. 1 is a table showing names of sounds and pitches of sounds.

FIG. 2 is a diagram showing a music staff.

FIG. 3 is a table showing correspondence between the sounds in Japanese and the notes expressing the sounds.

FIG. 4 is a table showing the characters in Japanese allotted to musical scales.

FIG. 5 is a table showing the letters of the alphabet allotted to musical scales.

FIG. 6 is a music staff having data in Japanese expressed on the music staff.

FIG. 7 is a music staff having word data expressed in letters of the alphabet on the music staff.

FIG. 8 is a block diagram of the data processor of the present invention.

FIG. 9 is a block diadem of note code memory.

FIG. 10 is a diagram showing a list of note code table.

FIG. 11 is a bit diagram of the data memorizing in the note code memory.

### DESCRIPTION OF THE PREFERRED EMBODIMENTS

An embodiment of the present invention will be described in detail with reference to the accompanying drawings. In an embodiment of the present invention, result of process produced by computer is made from input data input from keyboard basically. In the first processing method between expressed character and symbol data and signal data characterized by that a code table, scale in the music staff is correlated with each of the exhibited characters and symbols has previously been made. The exhibited character and symbol data which are input from keyboard are converted into data in the form of scales on the music staff in accordance with the code table whereby the characters and symbols are converted into an arrangement of data in the form of scales. The converted data are stored in the musical staff code memory. The data are output form the computer. In the computer, data in the form of scales are identified for another codes. That is, there is an enumerated musical staff code between key-code and particular code in the computer. The enumerated musical staff code are recognized to new key-codes in the computer, and are converted to various codes, finally, are output from computer as letters, tables, figures, and illustrations.

In the second processing method, as the same method of first it, scale in the music staff is correlated with each of the exhibited characters and symbols has previously been made. The exhibited character and symbol data which are input from keyboard are converted into data in the form of scales on the music staff in accordance with the code table whereby the characters and symbols are converted into an arranged data in the form of scales. The converted code data are processed. And various programs, tables are made from the converted code data. The results made from the converted code data are stored in the inner and outer memory. The memorized data are output from the computer.

On the other hand, the results are converted into data in the form of scales on the music staff in accordance with the code table whereby the characters and symbols are converted into an arranged data in the form of scales. The data are able to store in the music staff code memory, or are able to output from the computer. The enumerated musical staff code are recognized to new key-codes in the computer, and are converted to various codes, finally, are output from computer as letters, tables, figures, and illustrations.

In the present invention, characters and symbols on the key-board are converted to each scale of the note staff. Next, the note code which is corresponded with character etc and scale of note staff is explained.

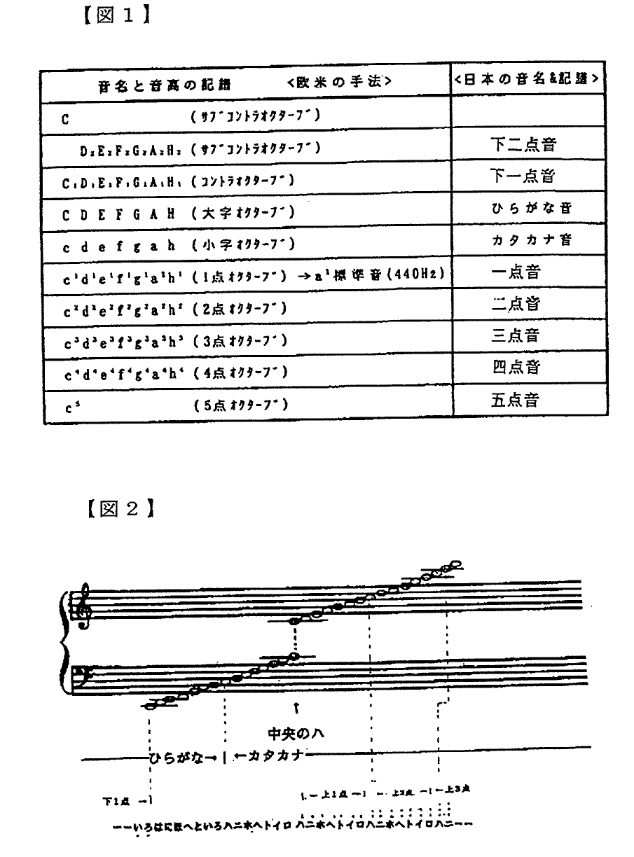

Musical sound is expressed by a combination of the pitch of tone, the length of tone, and the strength of tone. With respect to the pitch of tone, each tone in an octave is given one of the names c, d, e, f, g, a, and h (do, re, mi, fa, sol, la, and si). As for the pitch ranges, they are expressed, as shown in FIG. 1, by a “small letter octave” in the center, by “large letter octave”, “contra octave”, and “subcontra octave” in the direction they become lower in pitch, and by “one-dot octave”. “two-dot octave”, “three-dot octave”, “four-dot octave”, and “five-dot octave” as they become higher in pitch. These are represented, in the Japanese method of naming of tones, by “KATAKANA tones” in the center, by “HIRAGANA tones”, “tones with subscript 1”, and “tones with subscript 2” as they become lower in pitch, and by “tones with superscript 1”, “tones with superscript 2”, “tones with superscript 3”, “tones with superscript 4”, and “tones with superscript 5” as they become higher in pitch.

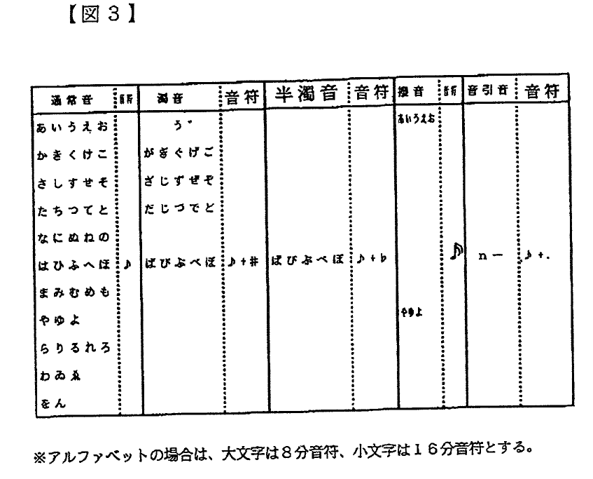

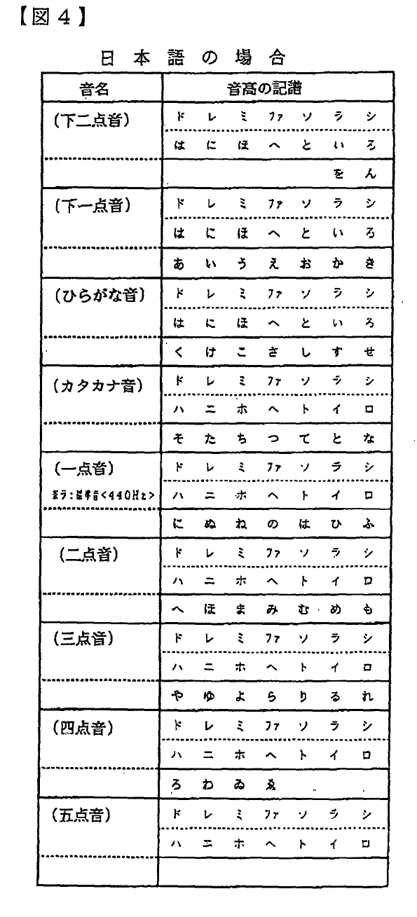

A piece of music is recorded on a score. The sore is expressed as notes written on music staffs. While the notes on a music staff represent pitches and the like, because of the great range of the pitches, the pitches of the notes are generally defined by a G clef and an F clef on a music staff. FIG. 2 shows a music staff on which the scales of notes are shown on the G clef and the F clef.

In the present invention, each of characters and symbols is correlated with each musical scale so that data made up of characters and symbols are expressed on a musical score. Ordinary sounds ( [symbol] (A), [symbol] (I), [symbol] (U), [symbol] (E), [symbol] (O), . . . ) are expressed by eighth notes, voiced sounds are expressed by eighth notes raised by one semitone (sharp), p-sounds are expressed by eighth notes lowered by one semitone (flat), and the syllabic nasal sounds are expressed by sixteenth notes. The elongating sound is expressed by a dotted eighth note.

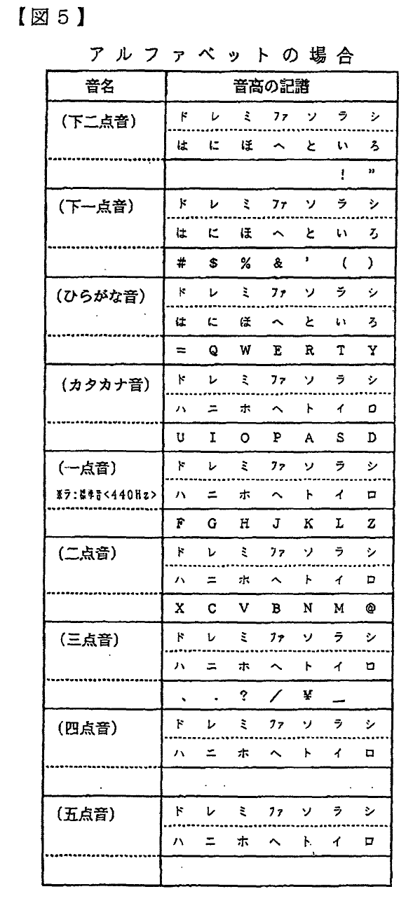

Each character of the 50 sounds of the Japanese syllabary is allotted to a scale. FIG. 4 is a table showing a code table prepared by allotting each of the Japanese characters to a scale. Incidentally, when KATAKANA characters are used in writing Japanese, they can be expressed by quarter notes.

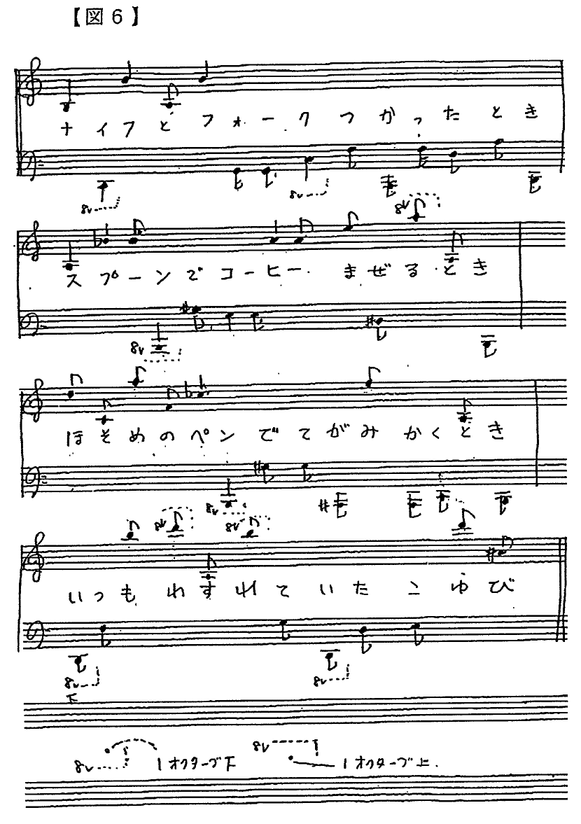

Allotment of each character to a scale can be applied also to the letters of the alphabet. FIG. 5 is a table showing a code table prepared by allotting each letter of the alphabet to a scale. When letters of the alphabet are expressed on a music staff, the capital letters are expressed by eighth notes and the small letters are expressed by sixteenth notes. Further, by employing such means of expression as long or short notes, flat and sharp symbols, and the like, it is made possible to broaden the application of the invention to include allotment of Chinese characters to notes on a music staff.

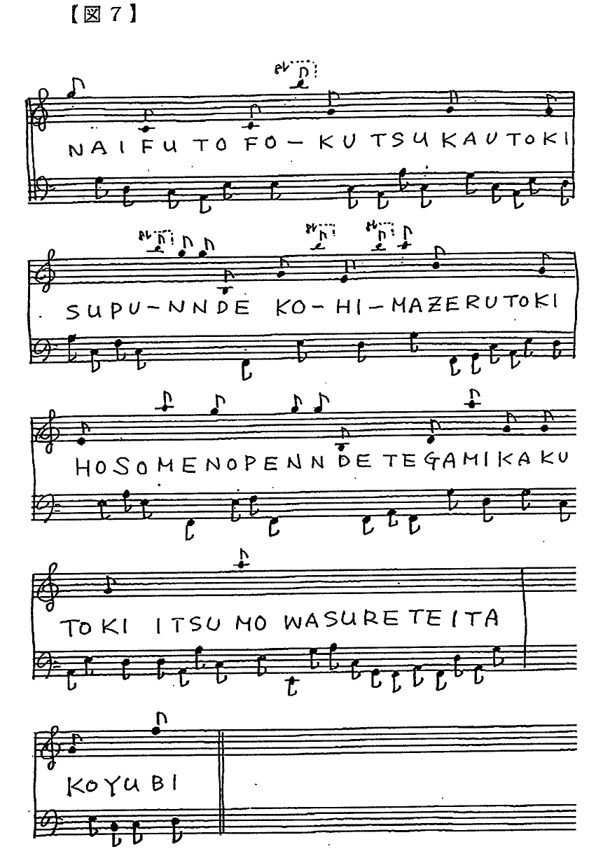

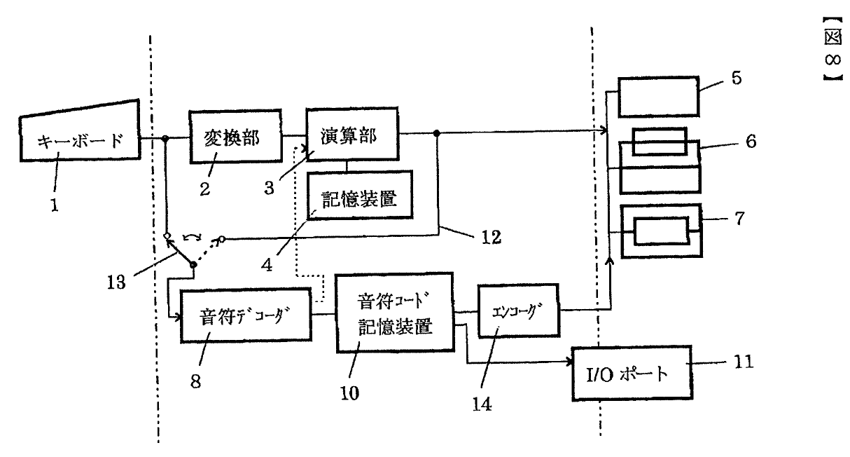

An example of a Japanese sentence, “ [symbol] [symbol] [symbol] [symbol] [symbol] [symbol] [symbol] ”, in which KATAKANA and HIRAGANA characters are mixed, expressed as notes on a staff is shown in FIG. 6. Further, an example of the same sentence written in Roman characters, “NAIFU TO OF-KU TSUKAUTOKISUPU-NNDE KO-HI-MAZERUTOKIHOSOMENOPENN DE TEGAMIKAKUTOKI ITSUMO WASURETEITA KOYUBI”, expressed as notes on a staff is shown in FIG. 7.

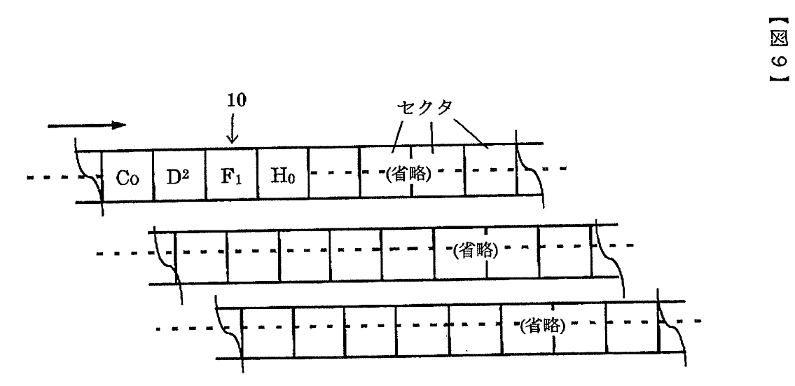

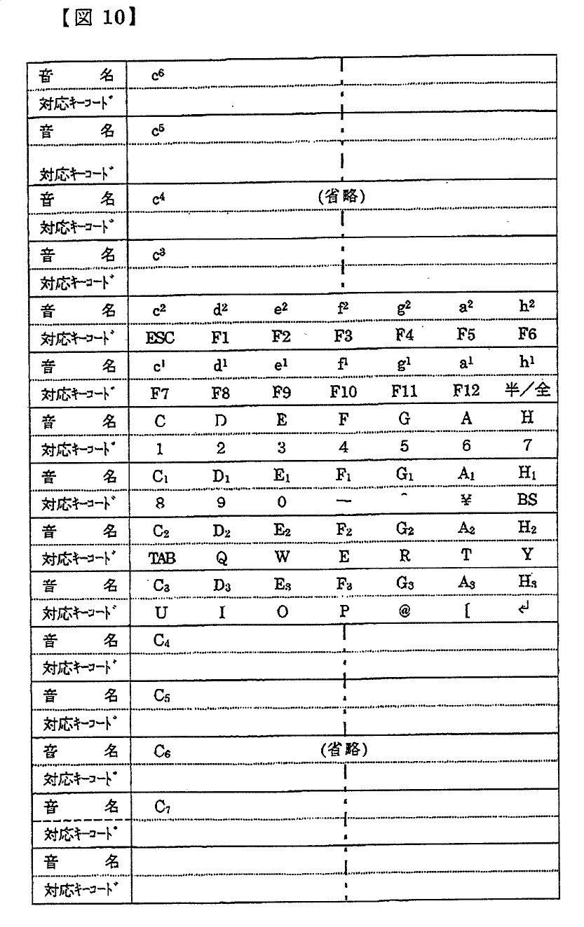

Next, a data processing apparatus according to the present invention using the above-mentioned data processing method will be described. FIG. 8 is a block diagram of the data processing apparatus. In FIG. 8, a key code entered from a keyboard 1 is provided to a conversion unit 2. The key code provided to the conversion unit 2 is converted in the conversion unit 2 into a character and symbol code according to existing code tables such as the JIS code table or the like. The encoded character and symbol data is provided to an operation unit 3 and undergoes various types of data processing. Data processing by a word processing software, for example, may generate words based on the entered character and symbol data set, referring to a dictionary stored in a storage device 4, while data such as the generated words may be displayed on a CRT 5, printed out to a printer 6, or stored in an external storage device 7 such as an FD, according to the instruction entered from the keyboard 1. The above-mentioned data processing is a well known procedure processed by conventional computers.

In the present invention, the character and symbol data entered from the keyboard 1 is also provided to a note decoder 8 through a branch path 9. In the note decoder 8, the character and symbol data entered from the keyboard 1 is converted into corresponding notes, according to the note code table shown in FIGS. 4, 5, or 10. Here, the note conversion is performed for all the keystrokes. For example, if a certain key is struck by mistake and the backspace key or the delete key is struck, the key codes corresponding to the mistaken key, and the backspace key or the delete key are converted into note codes, respectively.

The converted note codes are sent to a note code storage device 10 in succession. The note code storage device 10 consists of a long, shift-register-like, contiguous sequence of sectors partitioned by a few bits. The note codes transferred from the note decoder 8 in succession are stored in the sectors. The history of keystrokes on the keyboard 1 is called the key trace data.

The data stored in the note code storage device 10 can be transferred to other specific personal computers via an I/O port 11. In the specific personal computers, the data is encoded with the note-converted key trace data, and utilized in the form of files. Such a data processing method is close to MIDI, which can play music by transferring only the score but not the sound source, and inputting the score data into the sound board at the receiving site, with sound boards installed on both sites

The data stored in the above-mentioned note code storage device 10 is converted, by an encoder 12, into commonly used code data such as the JIS code or the like. The data can also be displayed on the CRT 5, printed out to the printer 6, or stored in the external storage device 7 such as an FD.

In the present invention, products such as the document data processed in the operation unit 3 and stored in the storage device 4 can be provided to the note decoder 8 via a route 12 and further, via a selector switch 13. In the note decoder 8, the character and symbol data transferred from the operation unit 3 is converted into corresponding notes according to the note code table. The converted note code is sent to the note code storage device 10 in succession, and the data stored in the note code storage device 10 can be transferred to other specific personal computers via the I/O port 11.

The note code tables shown in FIGS. 4 and 5 simply list the 50 sounds of the Japanese syllabary in pairs with their corresponding notes, or the alphabet characters in pairs with their corresponding notes.

However, the note code table, listing the 50 sounds of the Japanese syllabary in pairs with their corresponding notes, is also a reference table of character data and corresponding notes, the charade data expressing, for example, the 50 sounds of the Japanese syllabary converted from the key code set of roman characters entered from the keyboard.

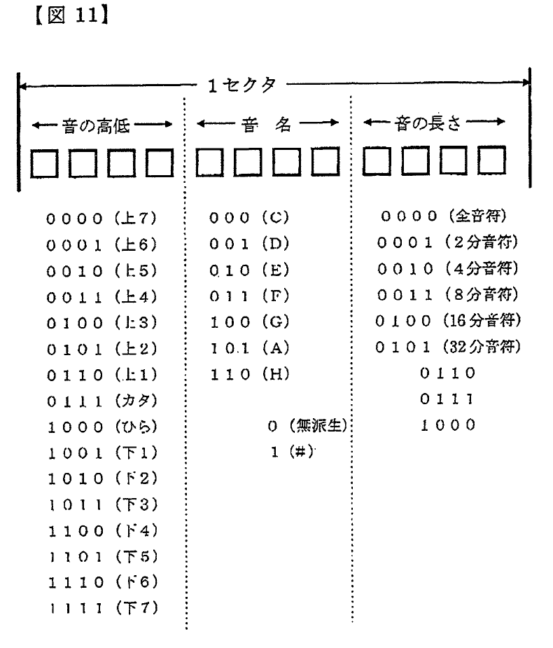

The actual note code table may be one that as notes respectively to all the keys arranged on the keyboard. That is, for a 106 keyboard, as shown in FIG. 10, it is sufficient to assign 106 types of notes one to each of the 106 keys. Besides, there is no fixed rule for the assignment. For example, there may be a method to generate a plurality of note code tables by arranging the keys on the keyboard in a certain order and assigning the notes to the keys with their correspondence being shifted. Another method to generate a plurality of note code tables may be such that the notes are arranged in sequence from lower ones to higher ones, and the keys are assigned to the notes with their correspondence being shifted. Furthermore, many note code tables may be generated by assigning the notes to the keys at random. In the present invention, any method may be used for providing correspondence between the keys and the notes.

In the present invention, as described above, a plurality of correspondence may be provided between the key code and the corresponding pitch name. As already discussed, there are also note code tables listing the 50 sounds of the Japanese syllabary in pairs with their corresponding notes, or the alphabet characters in pairs with their corresponding notes. In the present invention these are generally defined as the listing of note code tables.

Now, when implementing the present invention, the note decoder 8 and the encoder 12 must use the same listing of note code tables. Besides, a protocol must be determined so as to use the same listing of note code tables when communicating with specific personal computers for exchanging or using the note data at both sites, wherein decoding and encoding are carried out based on the same listing of note code tables at both parties. The note decoder 8 and the encoder 12 may be configured so as to support a plurality of listings of note code tables, in order to avoid mismatch of protocols by specifying the listing of note code tables to be used at the beginning of transmission of the note data to be transferred When such a configuration is adopted, a selection means for selecting the listing of note code tables must be provided in both the note decoder 8 and the encoder 12.

In the above mentioned embodiment, the note length is expressed by a quarter note. However, it is not necessary to express the note length by a quarter note, and the length of a whole note, a half note, an eighth note, a sixteenth note, or a thirty-second note may be used instead Therefore, the number of correspondences between the input signals and the notes can be increased to a greater extent. By changing the note length in this manner, signals to be entered into the computer are not limited to key codes from the keyboard, and code signs from other input devices may be used by converting them into notes.

FIG. 11 is a bit configuration diagram showing the bit configuration of the note code data stored in the note code storage device 10. Each sector is composed of a twelve-bit-long partition, the first four bits expressing the pitch of the sound, the next four bits expressing the pitch name and, considering the future expansion of the listing of note code tables, whether or not the data is a semitone, namely a sharp or a flat of the pitch name, and the last four bits expressing the length of the sound.

The present invention has been described with reference to the above-described embodiment. However, entering of data input is not limited to a keyboard, and any data input means such as a mouse, a digitizer, a scanner, a voice input apparatus or the like, can be used for a computer which can convert the input signals into data which can be matched with the listing of note code tables. Besides, the bit configuration of the note code data stored in the note code storage device 10 is not limited to twelve bits, it may be increased or decreased according to the attribute of the note code data. As can be seen, various modifications and applications are possible within the scope of the spirit of the present invention and these modifications and applications are not to be excluded from the scope of the present invention.

As described above in detail, in the invention according to claim 1 of the present application, because it is possible to convert an input signal, which is convertible into code data with a standardized code table, into note code data by a note decoder, it becomes easier to inversely convert the converted note code data into the input signal which is convertible into code data with a standardized code table. Therefore providing correspondence to an existing standardized code table is performed very smoothly. Since the converted note code data can express the entire input signals, including the function key code, the delete key code, or the like, the input history of which usually do not remain, in the storage device, enhanced utilization of the contents of the note code storage device such as analysis of input signals becomes possible. Besides, input signals are easily stored and data processing is simple, because a single code of the input signals can be expressed by a single note. Furthermore, the contents of the note code storage device can be exported via I/O means, so the contents transferred from a computer to another computer may be utilized by the other computer.

In the invention according to claims 2 to 5, there is an effect, in addition to the invention according to claim 1, that if one computer and another computer select the same listing of note code tables from a plurality of listings of note code tables, security-assured communication can be performed between both sites.

What we claim is:

1. A data processor using computer and a staff notation comprising:
a listing of note code table corresponding with data input to said computer and scales of music staff notation;
a note decoder decoding from input data to corresponded scale code data using said listing of note code table;
a note code storage device memorizing output data from said note decoder with in order;
an output means for output the music staff notation data from the note code storage device.

2. A data processor using computer and a staff notation according to claim 1, wherein said listing of note code table in the note decoder is a list corresponding with the input data arranged in order and plural scales of music staff notation arranged in random the scale.

3. A data processor using computer and a staff notation according to claim 1, wherein said listing of note code table in the note decode are plural list corresponding with the input data arranged in random and a scale of music staff notation.

4. A data processor using computer and a staff notation according to claim 1, wherein said listing of note code table in the note decode is a list corresponding with the input data arranged in random and a scale of music staff notation arranged in random.

5. A data processor using computer and a staff notation according to claim 1, wherein said plural listing of note code table in the note decoder are selectable listing.
